(19) United States
(12) Patent Application Publication
(10) Pub. No.: US 2008/0306726 A1
(43) Pub. Date: Dec. 11, 2008

(54) Machine-processable global knowledge representation system and method using an extensible markup language consisting of natural language-independent BASE64-encoded words

(76) Inventor: Gerard Jean Charles Levy, Brossard (CA)

Correspondence Address: ASHLEY J. WELLS, 27 Outlook Circle, Swannanoa, NC, 28778, US

(21) Appl. No.: 12/157,387

(22) Filed: Jun. 9, 2008

Related U.S. Application Data
(60) Provisional application No. 60/943,287, filed on Jun. 11, 2007.

(51) Int. Cl. G06F 17/28

(52) U.S. Cl. 704/2

(57) ABSTRACT

A global knowledge representation system and method using an extensible, language-independent markup language made up of KODAXIL encoded words, includes crafting a universal representation of knowledge in any natural language composed of words and symbols as a string of KODAXIL words which are an extensible set of BASE64 encodings of common and reserved vocabulary by assigning to each word and each symbol a KODAXIL word composed of an artificial handle derived in part using BASE64 encoding to encode within each KODAXIL word information about each word and symbol including lexical class of the word, other semantic information, and expression structure including implicit and explicit context markup; and stringing the KODAXIL words together to provide the universal representation of knowledge.

### CROSS-REFERENCE TO RELATED APPLICATIONS

This Application claims the benefit of priority of Applicant's earlier filed U.S. Provisional Patent Application No. 60/943287 filed on Jun. 11, 2007, and titled KODAXIL (KNOWLEDGE OBJECTS DATA ACTION EXTENSIBLE INTEROPERABLE LANGUAGE) AND KODAXIOM (KODAXIL OBJECT DESCRIPTOR AND ONTOLOGY MODELER), the contents of which are incorporated herein by reference.

### BACKGROUND OF THE INVENTION

1. Field of the Invention

This invention relates to a system and method for representing, storing, and conveying information which is grounded in the principle that all basic elements of human experience, thought and communication, i.e., persons, places, things, actions, and relations, can be reduced to language-invariant concepts. More particularly, this invention relates to a machine-processable global knowledge representation system and method which encodes species of cognitive ideas with a master key in a universal conceptual registry.

2. Background of the Related Art

Tim Bray, the co-inventor of XML (trademark), summarized the problem addressed by this invention by saying, “The web has a crying lack of machine-processable information.” Tim Bray was lamenting the lack of a global knowledge representation framework to enable machine-processing of multilingual, structured and unstructured input for the interchange of data and knowledge using a multi-lingual search engine.

Today, search engines search by words or phrases but most are limited to a specific language. The GOOGLE (trademark) search engine is somewhat more universal in that it can deliver information in the language of the user so that it is understandable. However, no linguistically-universal conceptual registry or instrument for global knowledge representation exists today and this is hampering the information industry.

Life processes as well as business objects and functions are universal. Physicians and dentists work in the same general way on a planet wide scale, as do pilots, truck drivers or almost any other occupation imaginable. Shipment documents include the same sender and recipient information. Packaging contents descriptions are used for the same purpose everywhere. Insurance details and the profile of a car, found in classifieds contains the same information whether in Tokyo or in Madrid, and so on.

Based on the trend within the IT industry to adopt open standards, one would expect better integration between disparate data sets affecting information platforms and measurement systems, e.g., metric, imperial, etc., than reports from the field indicate. Governments, corporations and other large organizations may find it difficult and costly to integrate heterogeneous data from their divisions, especially when information is represented in more than one spoken, i.e. natural, language such as when integrating or combining IT operations when companies merge. In these cases, subject matter expert knowledge reflecting competitive advantages, which is perhaps the most important asset of an organization, may be lost with potentially costly consequences.

Accuracy of data mining and web or predictive analytics techniques demands processing large datasets. However, multiple vendors offering numerous representation schemes, disparate datasets, textual data in foreign languages, and standard solutions unable to provide coherent frameworks, all prevent integration and make the application of data-mining techniques to extract business intelligence an uneasy and sometimes inaccurate process (see Data Mining: Introductory and Advanced Topics, Margaret Dunham. Prentice Hall: Upper Saddle River N.J. 2003).

Vital information provided to people speaking different languages generally misses a large number of those who can't grasp what is expressed in a language other than their own, as the tsunami catastrophe of December, 2004 revealed.

Technology that allows mining information hidden in unstructured text, such as e-mail messages and web content, is needed so it can reveal patterns of action, relationships, eventually warning of imminent threats and allowing thwarting of terrorist attacks (see Linguistic Data Consortium Program, DARPA).

Similarly, there is a need for a technology that allows for inference and building expert systems, all packaged in the same representation, using the same names to label the same objects, worldwide, in a generic way, not tied to natural-languages, as for mathematical representations, and not tied to any measurement system such as imperial or metric.

The entire IT industry relies heavily on XML. It is an open standard, well designed content markup, and new text-based files or communication formats are usually based on it. XML succeeded in providing partial interoperability but has not helped much in bringing expression of semantics and knowledge in ontology matching or in consolidating semantically identical data across languages. For instance, the proposition <EMPLOYEENO>111-222-333</EMPLOYEENO> is different than <EmployeeNo>111-222-333</EmployeeNo>. Further, computers still fail to understand that the proposition, <temperature unit=“Farenheit” value=“98.6” /> is identical to <temperature unità=“Farenheit” valore=“98.6”/> and to <temperatura unità=“Celsius” valore=“37”/>. Thus, XML has not succeeded in bringing global semantic interoperability to the IT world.

It is therefore an object of the present invention to provide a global knowledge representation system and method which encodes species of cognitive ideas with a master indexing key in a universal conceptual registry to enable machine-processing of multilingual, structured and unstructured input for the interchange of data and knowledge for bringing global semantic interoperability to the information industry.

### SUMMARY OF THE INVENTION

The present invention provides a global knowledge representation system and method using an extensible, language-independent markup language made up of KODAXIL (trademark) encoded words, comprising crafting a universal representation of knowledge in any natural language comprised of words and symbols as a string of KODAXIL words which comprise an extensible set of BASE64 (trademark) encodings of common and reserved vocabulary by assigning to each word and each symbol a KODAXIL word comprised of an artificial handle derived in part using BASE64 encoding to encode within each KODAXIL word information about each word and symbol including lexical class of the word, other semantic information, and expression structure including implicit and explicit context markup; and stringing the KODAXIL words together to provide the universal representation of knowledge.

The global representation system and method advantageously further comprises compiling at least one list of a plurality of strings of KODAXIL words into a KODAXIL knowledge database; and storing the KODAXIL knowledge base in a computer means so that the universal representations of knowledge are machine-processable.

The global representation system and method advantageously further comprises providing a KODAXIL thesaurus in one natural language having only one set of KODAXIL words; linking the KODAXIL knowledge base to the KODAXIL thesaurus; and associating a KODAXIL word in a KODAXIL lexicon of the KODAXIL knowledge base with a related KODAXIL word in the KODAXIL thesaurus so that each KODAXIL word in the KODAXIL lexicon acts as a key for access to grammatical information contained in the KODAXIL thesaurus which permits extension of the KODAXIL knowledge base through interchange and which permits extension of the KODAXIL thesaurus through interchange. The interchange permits aggregation of existing words, creation of new words, semantic context awareness, machine translation, object orientation and logical inferences.

The global representation system and method advantageously further comprises linking the KODAXIL knowledge base to another knowledge base; converting select knowledge in the another knowledge base into one or more strings of KODAXIL words; and associating select knowledge contained in the KODAXIL knowledge base with the select knowledge contained in the another knowledge base so that KODAXIL words and strings of KODAXIL words in the KODAXIL knowledge base act as keys for access to KODAXIL words and strings of KODAXIL words in the another knowledge base which permits universal interchange of data and knowledge in any natural language between knowledge bases which are made extensible thereby.

Associating in the foregoing comprises providing a KODAXIL base context for a word that can be found in a dictionary; and providing a KODAXIL context for each word so that the KODAXIL knowledge base and KODAXIL lexicon are linked with a context and with hyper-contexts including applications. Further, an augmented KODAXIL lexicon may be created and an augmented context on the fly for select applications may be created by selecting KODAXIL words from one of the KODAXIL lexicon or from the augmented lexicon to create objects.

The universal interchange of data and knowledge permits semantic context awareness, machine translation, object orientation, logical inferences, establishment of relationships, establishments of case-based meaning, and a list of all possible parents. Further, select knowledge contained in the KODAXIL knowledge base is a context which acts as a names pace and which may be created on the fly.

The KODAXIL words and strings of KODAXIL words serve as master indexing keys to any thesaurus and any knowledge base, and the KODAXIL knowledge base serves as a universal conceptual registry so that machine-processing of multi-lingual, structured and unstructured input for interchange of data and knowledge is enabled and global semantic interoperability is brought to the information industry. Further, the KODAXIL knowledge base is a KODAXIL based-system which allows conversion to and from XML, and wherein KODAXIL-based markup documents may be up to two-thirds smaller than that of XML counterparts. The KODAXIL knowledge base produces markup- and non-markup constructs as documents that may embed any amount of text or binary formats including multimedia.

Quantities contained in data and knowledge are expressed by respective KODAXIL words for quantity delimiter, unit, unit ratio, sign, absolute value expressed as a BASE64-encoded value, and end-quantity delimiter. The quantity delimiter and the end-quantity delimiter are positioned at respective ends of the quantity and are KODAXIL reserved words. KODAXIL words include a set of KODAXIL-defined reserved words which express information including markup information, measurement units, and logical connectors.

Each KODAXIL string is made up of a plurality of KODAXIL words that each have a numerical value ranging between 0 and 63 so that each of the plurality of KODAXIL words can be turned into pixels and so that a block of KODAXIL knowledge comprised of one or more KODAXIL strings turned into pixels expresses information as a graphic encoding. Logical operations may be applied to the pixel values of the plurality of KODAXIL words including (a) logical operations including “AND”, “OR”, and “XOR” or (b) bitwise operations including “AND”, “OR”, and “XOR”.

### BRIEF DESCRIPTION OF THE VARIOUS VIEWS OF THE DRAWING

While the specification concludes with claims particularly pointing out and distinctly claiming the subject matter which is regarded as the invention, it is believed that the invention, the objects and features of the invention and further objects, features and advantages thereof will be better understood from the following detailed description taken in connection with the accompanying drawing in which:

FIG. 1 shows an example of a concept according to the invention including an abstract idea or a general idea inferred or derived from specific instances;

FIG. 2 schematically exemplifies base and variant forms of the concept;

FIG. 3 is a schematic illustrating the link to the direct parent; and

FIG. 4 schematically exemplifies a Word as a Handle; and

FIGS. 5A and 5B schematically exemplify “Quick”, i.e., “Raw” translations of the same text showing the organization of subject and predicate; and

FIGS. 5C and 5D schematically exemplify translations of the same text showing the organization of subject and predicate but in a “Managed” way since they are represented, by way of example but not limitation, as Extended Backus Naur Form (EBNF).

### DETAILED DESCRIPTION OF THE INVENTION

The global knowledge representation system and method of this invention is known by the acronym “KODAXIL” (knowledge objects data action extensible interoperable language) or simply “KXL” and its grammar is defined in “KODAXIOM” (KODAXIL object descriptor and ontology modeler) terms. More recently, “KODAXIL” has additionally been known by the acronym “KML” (knowledge mark-up language) and reference herein to “KODAXIL”, “KXL” or “KML” are to be considered synonymous. The expressions “KODAXIL”, “KXL”, “KML”, and “KODAXIOM” are being used commercially as trademarks.

KODAXIL is a new encoding approach which allows one to turn information, i.e., knowledge, data, data structures, objects, processes, active and passive statements, facts, scripts, rules, propositions, predicates, formulas, coordinates or configurations, requirements or specifications, into a system (metric or imperial), language and platform-neutral representation that can be translated into any language for which a thesaurus exists.

KODAXIL is an extensible set of encoding of words based in part on BASE64 encodings derived from natural language (including meta-metadata) and which comprise common and reserved vocabulary unique to KODAXIL. BASE64 encoding is well known and the KODAXIL system and method builds upon this know encoding technique. These encodings act as keys pointing to extensible thesauri and contexts, allowing for semantic context awareness, machine translation, object orientation and inference. They also facilitate the creation of new words or aggregations of existing ones. KODAXIL contexts serve as namespaces and they may be created on the fly.

KODAXIL produces markup- and non-markup constructs that may embed any amount of text or binary formats including multimedia. KODAXIL-based markup documents may be up to two-thirds smaller than its XML counterparts. In order to leverage the huge investments made in XML, KODAXIL based-systems are designed to allow conversion to and from XML, as well as to and from databases.

KODAXIL's key architectural elements are discussed in the following and examples showing how KODAXIL is used to build application-specific libraries are given. The examples are directed to showing corporations a way to represent, store and convey information universally across divisions, languages, and almost any other boundaries that can be imagined.

Keywords which can help quickly define the discussion include multilingual knowledge representation, subject matter intelligence capture and reuse, knowledge representation and sharing, requirements and specification categorization, entity encapsulation and extraction, medical expert systems, and inference.

Input can be structured and unstructured. As used herein, “structured input” includes formatted text in paragraphs, headings, and the notion is extended to information obtained from databases where the column name makes the information consistent because it is always of the type defined for the specific column. As used herein, “unstructured input” includes data and knowledge, and, by way of example but not limitation, includes facts as propositions and predicates, a collection of statements using indicative mode, action as a collection of active statements using imperative mode, data, objects as structures containing properties and methods, rules, relations, and compositions including requirements and specifications, definitions, taxonomies, managed or free-form ontologies, files and documents, including XML or other markup. Input can originate in speech, databases, digital documents, web logs (a/k/a blogs), forums, chat rooms, web pages, emails, as well as hard paper copies, speech, databases, data warehouses, and all in various languages.

The present invention breaks the language barrier by providing a language-independent representation of anything and everything, i.e., data and knowledge, objects and actions. It is a generic language as opposed to a natural language, such as English or Greek. It expresses anything and everything from mathematical equations to text in various languages, permitting representation of data as quantities, ratios, etc. in the same coherent and universal way, and knowledge as facts and propositions, predicates, and action scripts.

The present invention breaks the system barrier by expressing all data in a standard universal format. Data is expressed as quantities and ratios. Knowledge is expressed as facts, propositions, predicates, action scripts, requirements, specification, and subject matter expert knowledge.

KODAXIL uses BASE64-encoded artificial words which may be encoded using UTF-7 or UTF-8 or other variants of BASE64-encoding, such as MIME content encoded using UTF-8, by way of example but not limitation. The KODAXIL encoded artificial words are known as “KODAXIL words” and are free from natural language connotations. Grammar and syntax encodings specify operations for these words, such as how to aggregate them or create new words, so that constructs of KODAXIL words and textual elements may be built in any language.

Each word of this extensible lexicon “knows” which lexical class it implements. Each word also carries length information for parsers to process them. Each word acts as a key to entries in various thesauri and to contexts, i.e., knowledge bases.

The thesauri provide grammatical information including synonyms and antonyms where applicable, and, for some languages, charset(s). The contexts are extensible without limit and eventually serve as namespaces for this non-XML universal markup they compose, using explicit markup including reserved words and implicit markup using word length.

This universal markup, as well as ontologies created using KODAXIL, can be understood in all languages for which a thesaurus exists. It is also measurement system-independent, i.e., metric, imperial, etc., and is one-third the size of XML counterparts. It also offers contexts which are important to web services.

The contexts store lists of all possible immediate parents letting the user implement backward and forward chaining. For instance, if “Socrates” is a man, man implements mammal, mammal itself implements “vertebrate” and the chain of direct parents leads to life, to its antonym “death” which links to “mortal”, an adjective. Hence, a KODAXIL constructs “knows” that all that is human and derived is mortal. This list of parents and relationships with other words is extensible, without a limit.

Moreover, this extensible construction set helps create sentences and markup constructs that can be understood in languages for which a thesaurus has been implemented. It provides a unique naming convention for similar objects or business objects, atomic or complex, on a planet wide scale, as it consists of a generic language, and a grammar and syntax for sentences and objects. It allows building custom sets of relationships that result in definitions, ontologies, and libraries of business objects, atomic and aggregates (objects) for use on a planet wide scale.

The contexts also contain all possible meanings for a word, case base examples of usage and translations. In markup constructs, a context can be used as a namespace to disambiguate a specific object.

The global knowledge representation system and method (1) translates structured and unstructured input into language-invariant concepts, (2) encodes such concepts into a generic language free from natural-language connotations, also free from system information, such as metric or imperial systems, objects and action, including marked-up documents, and (3) associates the representations with contexts and tools are provided for development of intelligent systems that allow inferences based on these representations. The contexts are also extensible since to each word can be associated an infinite number of contexts of any size.

Practical applications of KODAXIL are found in machine translation, universal markup language and business libraries used on a planet wide scale, and multilingual search engines allowing for searches by concept, standards and protocols. Additional applications include extensible general and specialized domain representation, facilitating creation of more domain representations, and for applying logic rules (inference) to these expressions, as well as providing semantics to content expressed using KODAXIL, e.g., (a) elements of language such as base and augmented lexicons, grammar and syntax, thesauri, and knowledge bases contexts, and (b) domain specific contexts such as augmented words, thesauri, contexts, some defined on the fly, part of domain discovery in new applications for instance, or hybrids, using existing and new bases. Sample applications include but are not limited to air security, flight plans, delay codes, text analysis, including web data analysis, terror attack thwarting, and data mining large datasets.

Note that in KODAXIL, some grammatical elements such as verb conjugation are already expressed in the value that is computed before BASE64-encoding. Each word ‘knows’ (and parsers know too) the tense, mode, and all other attributes of a word depending on its lexical class and usage in a sentence.

Also note that KODAXIL can be considered as ‘an artificial mind’, as it provides a generic representation of knowledge based on concepts, and both the building blocks [knowledge bases], and structural elements to create/modify knowledge-based systems, only at the pre-verbal and pre-systemic expressions.

Traditionally, efforts (Adobe, Wordnet, Framenet, TOGAF, etc.) have been adding metadata to digital resources. This allows attaching a tag, or collection of tags, with a resource to bring meaning to those actors (human or computer) who use the resource. The semantic web effort also tends to attach a meaning to objects through XML-based technologies.

The present invention does this differently using KODAXIL words. These are artificial words, handles, BASE64-encoded handles to base and variant forms of words, synonymous canonical forms of each word.

These artificial words are used in lieu of words in natural language representation, and stored or expressed in constructs, in accordance with the grammar and syntax that rule their usage. Each of these words carries semantic information about its lexical class and length, and acts as a key to thesauri and contexts.

The elements that constitute the present invention include:

(1) a KODAXIL common word base of currently close to 8 million neutral and variant forms of words;

(2) thesauri that contain information specific to some natural language, e.g., ‘sun’ may be masculine in some language, feminine or neutral in another;

(3) contexts or knowledge bases;

(4) a grammar that rules the aggregation of existing words;

(5) a syntax that determines the base alphabet, the layout of words in KODAXIL constructs, markup, rules, expression of knowledge, and the ability one has to infer from these expressions; and

(6) a “word sense disambiguation” (WSD) module or “word sense resolver”

The concept of a WSD module is not new. However, the way context is organized for disambiguation, techniques to disambiguate, and searches, which are efficient from both accuracy and performance perspectives, may vary from one implementation to the next. All unstructured text analysis software has a word sense disambiguation module.

Humans understand text or speech and communicate by using words in context(s). Words let one shape and express thoughts, feelings, knowledge, action, and concepts, or define objects (The World is a Text: The Writing, Reading, and Thinking About Culture and Its Contexts, 2nd edition. Jonathan Silverman, Dean Rader. Prentice Hall: Upper Saddle River N.J. 2006.). Semantics are best expressed using words rather than constructs where words have no meaning per se, and if computers can ‘recognize’ words, then this statement also applies to them.

All languages include words, syntax, and grammar that rule the organization of these words. These parts of speech, i.e., verb, noun, conjunction, verb, adverb, adjective, names, etc., named ‘semantic invariants’, exist in all languages. In addition, another line of semantic invariants lies in roles and denotative meaning, i.e., some verbs denote “sensorial information”, such as ‘hear’, ‘touch’, etc., while some denote feeling, etc. These attributes, common to various languages in various linguistic groups, are universal.

Each language expresses things in its own way, but carries all the semantics required to convey information to other humans in the same language, sometimes with some redundancy. Whether a phrasal representation involves many or few words, all languages express the same universal concepts. This fact enables a translator to convey meaning from one language to another without altering its meaning (semantic reduction).

The design of KODAXIL is based on Chomsky's theory of language (see The Architecture of Language, Noam Chomsky, Oxford University Press: New York, 2006) and Wittgenstein's essences/universals (see Tractatus Logico-Philosophicus, Ludwig Wittgenstein, Routledge, London, 1981). The design of KODAXIL requires extracting semantic invariants from 10 languages in six major linguistic groups, i.e., Sino-Tibetan, Semitic, Indo-European, Ural Altaic, Japanese, and Ghanaian (Congo Niger), which altogether are understood by up to 95% of humans on this planet, to create a language-neutral lexicon, grammar, and syntax, and gathering all semantic elements of a phrase so it can be rendered in any other natural language, thus resulting in a generic natural language as opposed to local natural languages such as English, Greek, etc.

The structural elements of KODAXIL include words. As a generic language, KODAXIL employs a one-to-one mapping of each word found in any dictionary and their variants, with a BASE64-encoded handle that contains “lightweight metametadata”.

The meta-metadata provide (a) lexical class as grammatical function of the word, (b) length information. i.e., each word of the common vocabulary in the word base contains only pure printable ASCII characters; objects/complex structures use a specialized bit for parsers to determine their length (floating offset), and (c) additional information (meta-metadata) expresses semantics specific to the lexical class the word belongs, e.g., nouns include gender, neutral, singular, plural, verbs include tense, mode, transitivity, etc., adverbs include time, manner, places, names of people, events, etc.

KODAXIL's markup documents are two-thirds smaller on average than corresponding XML constructs and can be understood in many languages which permits converting the quantity data they embody between systems. Each word is on par with close to all existing words. They amount to close to 220,000 11 in their neutral form.

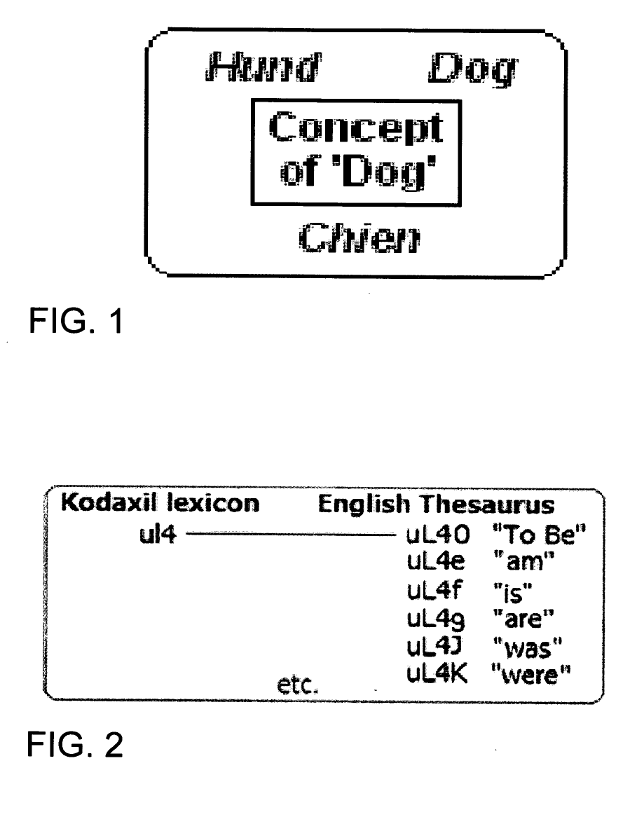

FIG. 1 shows an example of a concept according to the invention including an abstract idea or a general idea inferred or derived from specific instances. FIG. 2 schematically exemplifies base and variant forms of the concept. With the variant forms and reserved words, the lexicon amounts to approximately eight million words, using the four sextets which allow representing 2̂(24−1)=8,388,608 words, which makes KODAXIL one of the largest existing annotated corpora (annotation is encoded). Thus, each KODAXIL word acts as a unique key to associated structures. KODAXIL also comprises a set of reserved words representing primitives, connectives, or explicit markup elements.

Thesauri in various languages contain grammatical, character set, synonym, and antonym information. A thesaurus contains grammatical information for a target language. A word can be masculine in one language, feminine in another, and neutral in yet another. All thesauri have the same cardinality to map words across thesauri. Augmented thesauri contain compositions of words that use the base lexicon. They can be created on the fly and may become part of the domain of an application.

Inference: Knowledge bases are known as auxiliary files, or contexts. They include lineage information bringing object orientation and inference, e.g., “man” and “woman” are “human”, human has a body attribute, “body” has a “gender” attribute, human is a “mammal” (direct parent class), which derives from ‘vertebrate’. The backward chaining leads to “implements life”, itself linked to “death” as its antonym”, “death” links to “mortal”. Therefore, if “Socrates” is a “man,” then the KODAXIL representation “knows” that “Socrates is mortal”. Lineage enables one to compose ontologies/taxonomies, and KODAXIL can establish relationships between objects in various languages. These ‘contexts’ or ‘knowledge bases’ are also used as namespaces when applicable (see further).

A grammar and a syntax, defined in KODAXIOM, edict rules, and the sequence of (a) creation of new words, and associated auxiliary lexicons, thesauri, and auxiliary files, allowing for specialized thesauri (medicine, aerospace), and (b) composition and aggregation of words, either from the base lexicon, or new words mentioned above. Composition of words can help create variables and method names, e.g., Saved Date, Load Page, etc., representing business objects, events, and statements to help create data dictionaries on the fly, making this language extensible ad infinitum.

All KODAXIL constructs are represented as strings of BASE64-encoded words to guarantee that data-exchange and communication are void of endian or double-byte concerns, freeing computing and data exchange from issues inherent to local natural languages and platforms. Raw text (text not represented as KODAXIL words), as well as binary objects, is also BASE64-encoded. Thus, KODAXIL and XML employ different character set information.

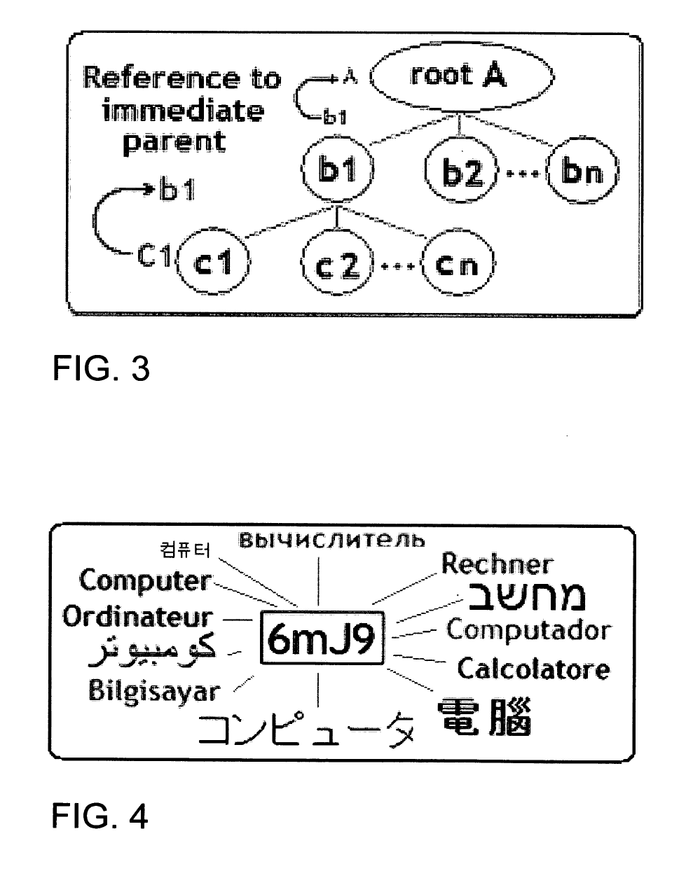

FIG. 3 is a schematic illustrating the link to the direct parent. With reference to FIG. 3, each KODAXIL word is a proxy (a naming service) to a ‘local’ natural word, an encoded representation of its counterpart in various local natural languages. For instance, “mA6n” may represent “go up” in English, “monter” in French, “subir” in Spanish, and “salire” in Italian. KODAXIL can process concepts expressed as one word in some language that can be rendered as two or more words in other languages, in English or in Mandarin, for instance (semantic entities).

FIG. 4 schematically exemplifies a Word as a Handle. FIG. 4 shows the same KODAXIL word and its counterpart in various natural languages. Each word is a proxy (a naming service) to a ‘local’ natural word and to its counterpart in various languages. KODAXIL is able to accommodate occurrences of the absence of an equivalent or the presence of multiple equivalences in a foreign language.

Most languages contain redundancy. Another line of semantics resides in the semantic alignment of different classes of words (roles, functions), and semantic equivalence uses the same sequence number For example, if the code is “01” for “verb,” “02” for noun, “03” for adjective, and “04” for adverb, and if the sequence number for the verb “to argue” is “224,” then its key is “01224,” while the code for the noun “argument” is “02224,” the code for the adjective “arguable” is “03224,” and “04224” for “arguably” (the adverb “argumentative” corresponds to another verb). This is before the word is BASE64-encoded. In the current implementation, “01” “02” etc., and “224” are encoded in separate sextets.

The following exemplify information or knowledge: (a) “The President goes to China.”; (b) “Tomorrow, wind will be east 15 to 20 mph with gusts to 25 mph and temperatures will remain in the low 50s for New Hampshire.”; and (c) a script or an algorithm use the imperative mode, for example, “(b²⁾−(4ac)” can be represented as a sequence of statements: (1) multiply b by b, (2) multiply 4 by a by c, and (c) subtract the result of the second step from the result of the first.

The following exemplify requirements so critical to the software development process: (a) “The ‘Save’ button must be enabled for Managers; it must be disabled for other staff.”; (b) “The view must be sorted by employee name, in ascending order.”; and (c) Expressing procedures to follow when events occur (a/k/a ‘Bibles”). These semantic objects share at least one common feature, that is, information, knowledge, belief, data, facts, requirements, and specifications, and all are expressed using words, and all are understood due to grammar and syntax.

Facts, raw text (unstructured), and generally speaking information or documents, are stored as chains (strings) of BASE64-encoded strings of KODAXIL words that can comprise a mix of base words and raw text, eventually interspersed with words from the base or augmented lexicon, as well as text in various (local) natural languages, prefixed with their character set, or any binary object (multimedia) prefixed with its MIME type. Objects/complex types/are built using KODAXIL markup elements (see illustrative cases comparing KODAXIL and XML).

KODAXIL parsers let one process text in some language, extract sentences, and compare each phrasal element with its counterpart in the thesaurus for that language, yielding corresponding KODAXIL words and storing them as determined by the grammar. Some modules will help propose alternative word(s) if a source word is misspelled. Other modules will help disambiguate the meaning when necessary. The illustrative cases below provide more about the domains of application of this technology.

A document is writing that contains information. It can contain various types of data, such as text expressed in a local natural language, images, sound, video, other binary data, tables, and parts of other documents. The client application, such as “Open Office” or “Microsoft Word”, knows how to render the various parts of the document by analyzing formats placed in the document. Otherwise, it displays a warning that it cannot render some part of it.

Markup can be implicit or explicit and has existed since the inception of writing under various forms, and not only the form exhibited by SGML or XML. For instance, you could have read the following menu in a restaurant in Paris two centuries ago:

Entrées
Saumon fumé dans une coupe de melon au Porto
Escargots de Bourgogne sur lit de morilles

Plat Principal
Sanglier aux bolets d'Auvergne
Cotes de boeuf à la moëlle sauce marchand de vin

Plateau de Fromages

Desserts
Crème brulée
lies flottantes

In the above menu document, the explicit markup consists of carriage returns and indentations (tabs). In digital content, it could also consist of specific words to inform parsers about the layout of the document, among other information. Implicit markup may use information such as words that are ‘length-aware’ for parsers to ‘understand’ the syntax. Color and typeface may augment information as well.

### ILLUSTRATIVE EXAMPLES

### Example 1

### Comparing KODAXIL and XML Representations of the Same Information

The following XML document uses 27 words and 256 characters and can be understood by English speakers only.

<-xml version=‘1.0’ encoding=‘utf-8’->
<CustomerName xmlns=“http://tempuri.org/CustomerName.xsd”>
<CustomerName>
<NameType>Person</NameType>
<PersonName>
<FirstName>John</FirstName>
<LastName>Armsby</LastName>
</PersonName>
</CustomerName>

The KODAXIL counterpart is a 71-character, pure printable ASCII string: Fce83mlJjkeNhjV7t6yag3p0jkehM6USm9obg==n88rkj4rhM6UQXJtc2J5n88ri8ux i8ux

Thus, the KODAXIL counterpart is two-thirds smaller than its XML counterpart. It can be understood worldwide using client tools to decode it. It is platform and system (metric, imperial) independent.

After inserting spaces between words, the KODAXIL string looks like: Fce8 3mlJ jkeN hjV7 t6ya g3p0 jkeN hM6U Sm9obg== n88r kj4r hM6 QXJtc2J5 n88r i8ux i8ux.

In the KODAXIL string, “Fce8’ specifies the default language and character set of text for the whole document, here, “en-US” and “ISO-8859-1.” These are found in the default, or base, thesaurus. If a specific string needs different encoding, it will be specified immediately after ‘hM6U’, a reserved word for [beginning of] ‘text’ itself. The parser is aware of the length of each word, element, or construct.

In the example presented above, “Sm9obg==” (“John”) and ‘QXJtc2J5’ (“Armsby”), respectively, First Name and Last Name, may have been extracted from a database, from a web form, or from another input method, and they have been BASE64-encoded. In KODAXIL terminology, they are raw text.

### Example 2

### Quantity, an Example of a KODAXIL Object

Elements frequently found in data interchange are identity, percentage, and quantity. A study of existing frameworks—including uncefact, wordnet, toga, ebXml, UDEF, UDR, Cyc—shows that most of these consider time, money, and other quantities as different entities. From a formal standpoint, however, there is no difference between a temperature expressed in degrees (Celsius, Fahrenheit, Kelvin, etc.), a currency expressed in dollar or yen, time, or distance expressed in yards. All can be expressed as UNIT, UNIT RATIO, SIGN, and VALUE.

These are parts of KODAXIL reserved words. For example, one of two representations involves the KODAXIL reserved words “quantity” and “end-quantity.” A temperature such as 98.6° F. will be expressed as “gMe2hTTyyGn6+PYgMf3” in which

$${g}_{1} Me 2 {hT}_{2} Ty y {G}_{3} n 6 + {PY}_{4} {g}_{5} Mf {3}_{6}$$

correspond to (1) the quantity (reserved word), (2) UNIT degree Fahrenheit (reserved word), (3) UNIT RATIO 1/10 (reserved word), (4) plus sign is not part of the BASE64-encoding set, but is part of syntactic rules, (5) value: 986=15*64+24, or‘PY’ once BASE64-encoded [absolute value], and (6) end-quantity (reserved word).

The result uses 19 bytes. It can be understood in various languages using KODAXIL tools. It amalgamates various semantics into the same construct (augmented information). It can be stored in a database where the augmented information reduces the storage size. It allows for automatic equivalence between systems (imperial, metric, etc.). KODAXILKODAXIL internal representation uses the International System of Units, symbolized SI.

### Example 3

### Other Usage Cases

After showing that KODAXIL can represent XML constructs and bring ubiquity, one can envision that KODAXIL may represent all XML constructs, build libraries of business objects, atomic and aggregates, so they are equally understood worldwide using KODAXIL tools and thesauri. This allows for large-scale integration and data mining on very large sets as previously mentioned.

By offering corporations a way to represent, store and convey all information and data across divisions and languages, KODAXIL protects their knowledge assets. As for text representation and machine translation, KODAXIL tools can find the boundary of sentences, and turn sentences into strings of KODAXIL words, allowing for text analysis when converting each word found in some language into a string of KXL words as shown below.

### Example 4

### Quick Translation

Simple rules allow for providing a quick translation of the above KODAXIL string. Business Objects may use the neutral grammatical form. There is no need for translation rules since the sequence and metadata contained in words suffice to express the semantics. For instance, the atomic business object “SaveDate” can be immediately rendered as “DateSauvegarde” which will be understood as the French equivalent. The usual representation strips the text from all local parts while conserving all semantic elements that allow translation to other languages. It does this by representing sentences, questions, and predicates using KODAXIL words, in the sequence determined by KODAXIL grammar and syntax.

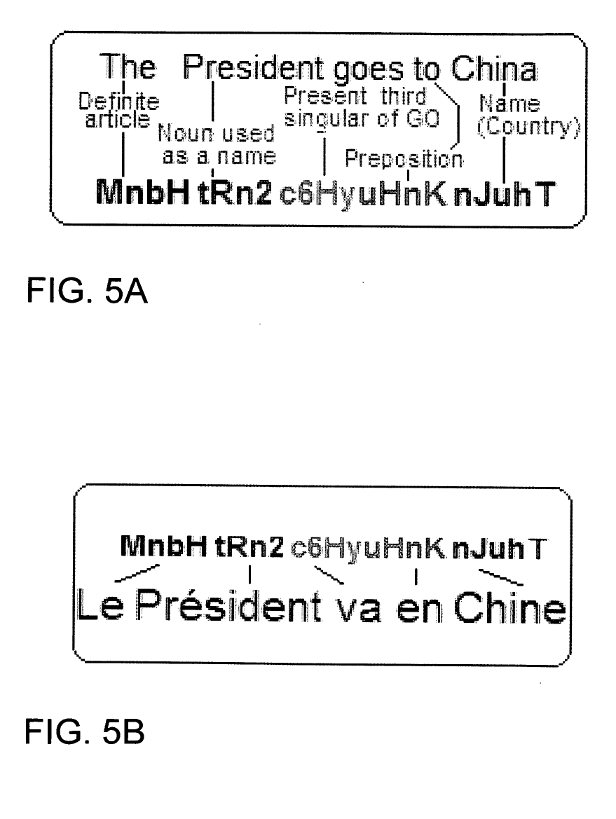

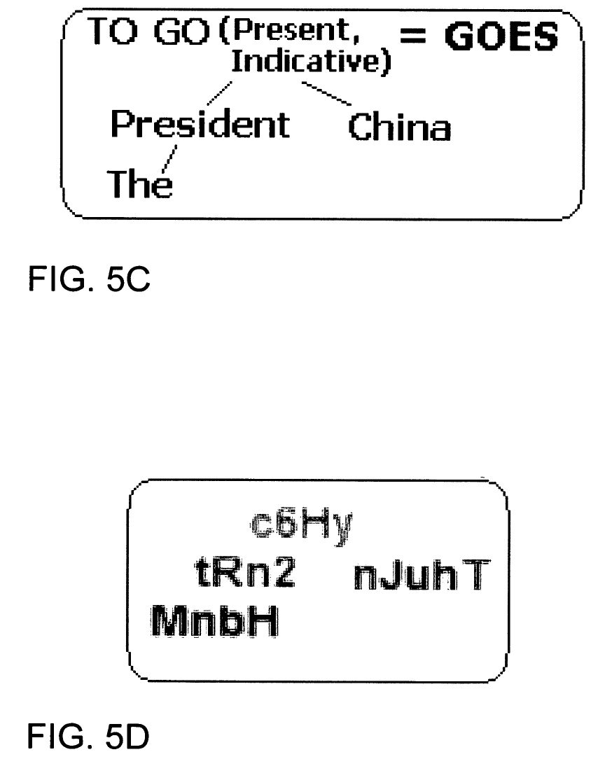

FIGS. 5A and 5B schematically exemplify “Quick”, i.e., “Raw” translations of the same text showing the organization of subject and predicate, and FIGS. 5C and 5D schematically exemplify translations of the same text showing the organization of subject and predicate but in a “Managed” way since they are represented as Extended Backus Naur Form (EBNF). For example, (1) article; form: definite; person: singular, masculine, i.e., Words must include gender information, even though it may not be used in some languages, to provide a counterpart (key) in languages that use it; (2) verb =‘to go’; tense =‘present’; person: third, singular, masculine; (3) connective implying direction; and (4) country name. The string contains all elements that allow translation to any language, as FIGS. 5A-5D show.

KODAXIL can help represent all types of information, package facts, scripts, data, in other terms, knowledge, build universal business libraries, produce very large datasets for accurate data mining, web and text analytics, understand unstructured text, and readying this information for use in various languages. The semantic interoperability it brings lets one envision the design of web services with contexts, described in various languages that collaborate.

Information structured using KODAXIL allows encapsulating knowledge in corporations and federal agencies, improving subject matter expert's knowledge, storage and reuse, and communication, as well as expressing requirements and specifications in software projects, all known as collective data intelligence, therefore cutting costs drastically.

One can envision people speaking different languages using it to converse in real time (aircraft to flight traffic control towers) or for speech recognition. With regard to applications, KODAXIL can be used to build knowledge-based systems in expert arenas, such as risk analysis and assessment, a feature especially useful in an outsourcing context.

For medical diagnosis, KODAXIL allows systematize medical knowledge representation to provide accurate primary and differential diagnosis, for teaching and learning clinical medicine by placing students in situ, in the same way flight simulators do for pilots, and for disease control and prevention (practical day-to-day use). Medical search engines can benefit from KODAXIL when medical knowledge has been defined. Another project has been initiated to allow fast retrieval of complex information (search engines by concept).

KODAXIL will also be proposed in the field of machine translation to extract information from large unstructured information in various languages.

Because of its very small footprint, KODAXIL may find use in cellular phones or other media, eventually to convey emergency event decision making messages in various languages. KODAXIL is also considered to be the key to multilingual search engines, search engines by concept, and a new non-XML based alternative to the Semantic Web.

The open source movement will also help the set of base words and primitive to evolve towards a full-fledge universal instrument for projects and idea interchange.

While the present invention has been described in conjunction with embodiments and variations thereof, one of ordinary skill, after reviewing the foregoing specification, will be able to effect various changes, substitutions of equivalents and other alterations without departing from the broad concepts disclosed herein. It is therefore intended that Letters Patent granted hereon be limited only by the definition contained in the appended claims and equivalents thereof.

What is claimed is:

1. A global knowledge representation system and method using an extensible, language-independent markup language made up of KODAXIL encoded words, comprising:
crafting a universal representation of knowledge in any natural language comprised of words and symbols as a string of KODAXIL words which comprise an extensible set of BASE64 encodings of common and reserved vocabulary by assigning to each word and each symbol a KODAXIL word comprised of an artificial handle derived in part using BASE64 encoding to encode within each KODAXIL word information about each word and symbol including lexical class of the word, other semantic information, and expression structure including implicit and explicit context markup; and
stringing the KODAXIL words together to provide the universal representation of knowledge.

2. The global representation system and method according to claim 1, further comprising:
compiling at least one list of a plurality of strings of KODAXIL words into a KODAXIL knowledge database; and
storing the KODAXIL knowledge base in a computer means so that the universal representations of knowledge are machine-processable.

3. The global representation system and method according to claim 2, further comprising:
providing a KODAXIL thesaurus in one natural language having only one set of KODAXIL words;
linking the KODAXIL knowledge base to the KODAXIL thesaurus; and
associating a KODAXIL word in a KODAXIL lexicon of the KODAXIL knowledge base with a related KODAXIL word in the KODAXIL thesaurus so that each KODAXIL word in the KODAXIL lexicon acts as a key for access to grammatical information contained in the KODAXIL thesaurus which permits extension of the KODAXIL knowledge base through interchange and which permits extension of the KODAXIL thesaurus through interchange.

4. The global representation system and method according to claim 3, wherein the interchange permits aggregation of existing words, creation of new words, semantic context awareness, machine translation, object orientation and logical inferences.

5. The global representation system and method according to claim 2, further comprising:
linking the KODAXIL knowledge base to another knowledge base;
converting select knowledge in the another knowledge base into one or more strings of KODAXIL words; and
associating select knowledge contained in the KODAXIL knowledge base with the select knowledge contained in the another knowledge base so that KODAXIL words and strings of KODAXIL words in the KODAXIL knowledge base act as keys for access to KODAXIL words and strings of KODAXIL words in the another knowledge base which permits universal interchange of data and knowledge in any natural language between knowledge bases which are made extensible thereby.

6. The global representation system and method according to claim 5, wherein associating comprises:
providing a KODAXIL base context for a word that can be found in a dictionary; and
providing a KODAXIL context for each word so that the KODAXIL knowledge base and KODAXIL lexicon are linked with a context and with hyper-contexts including applications.

7. The global representation system and method according to claim 6, further comprising:
creating an augmented KODAXIL lexicon; and
creating an augmented context on the fly for select applications by selecting KODAXIL words from one of the KODAXIL lexicon or from the augmented lexicon to create objects.

8. The global representation system and method according to claim 5, wherein the universal interchange of data and knowledge permits semantic context awareness, machine translation, object orientation, logical inferences, establishment of relationships, establishments of case-based meaning, and a list of all possible parents.

9. The global representation system and method according to claim 5, wherein select knowledge contained in the KODAXIL knowledge base is a context which acts as a namespace, and which may be created on the fly.

10. The global representation system and method according to claim 2, wherein the KODAXIL words and strings of KODAXIL words serve as master indexing keys to any thesaurus and any knowledge base, and the KODAXIL knowledge base serves as a universal conceptual registry so that machine-processing of multi-lingual, structured and unstructured input for interchange of data and knowledge is enabled and global semantic interoperability is brought to the information industry.

11. The global representation system and method according to claim 2, wherein the KODAXIL knowledge base is a KODAXIL based-system which allows conversion to and from XML, and wherein KODAXIL-based markup documents may be up to two-thirds smaller than that of XML counterparts.

12. The global representation system and method according to claim 2, wherein the KODAXIL knowledge base produces markup- and non-markup constructs as documents that may embed any amount of text or binary formats including multimedia.

13. The global knowledge representation system and method according to claim 1, wherein quantities contained in data and knowledge are expressed by respective KODAXIL words for quantity delimiter, unit, unit ratio, sign, absolute value expressed as a BASE64-encoded value, and end-quantity delimiter, and wherein the quantity delimiter and the end-quantity delimiter are positioned at respective ends of the quantity and are KODAXIL reserved words.

14. The global representation system and method according to claim 1, wherein KODAXIL words include a set of KODAXIL-defined reserved words which express information including markup information, measurement units, and logical connectors.

15. The global representation system and method according to claim 1, wherein each KODAXIL string is made up of a plurality of KODAXIL words that each have a value ranging between 0 and 63 so that each of the plurality of KODAXIL words can be turned into pixels and so that a block of KODAXIL knowledge comprised of one or more KODAXIL strings turned into pixels expresses information as a graphic encoding.

16. The global representation system and method according to claim 14, further comprising applying logical operations to the pixel values of the plurality of KODAXIL words including (a) logical operations including “AND”, “OR”, and “XOR” or (b) bitwise operations including “AND”, “OR”, and “XOR”.
